(19) United States
(12) Patent Application Publication
(10) Pub. No.: US 2026/0120951 A1
(43) Pub. Date: Apr. 30, 2026

(54) MULTILAYER CERAMIC ELECTRONIC COMPONENT AND DIELECTRIC CERAMIC COMPOSITION

(71) Applicant: TAIYO YUDEN CO., LTD., Tokyo (JP)

(72) Inventor: Kazuki MISAWA, Tokyo (JP)

(73) Assignee: TAIYO YUDEN CO., LTD., Tokyo (JP)

(21) Appl. No.: 19/365,058

(22) Filed: Oct. 21, 2025

(30) Foreign Application Priority Data
Oct. 29, 2024 (JP) 2024-189875

(51) Int. Cl. H01G 4/12; C04B 35/468; C04B 37/00; H01G 4/30

(52) U.S. Cl. CPC H01G 4/1227; C04B 35/4682; C04B 37/001; H01G 4/30; C04B 2235/3206; C04B 2235/3224; C04B 2235/3236; C04B 2235/3256; C04B 2235/3418; C04B 2235/442; C04B 2235/768; C04B 2235/786; C04B 2237/346; C04B 2237/68

(57) ABSTRACT

A multilayer ceramic electronic component includes a dielectric layer including first crystal grains and second crystal grains, the first crystal grains having a perovskite structure represented by a general formula ABO₃ and having a core portion containing molybdenum and a shell portion, the shell portion covering the core portion and containing a rare earth element and manganese, the second crystal grains including, as a main component, a barium titanate-based composite oxide and having an elemental ratio of barium to titanium of 0.70 or less, internal electrode layers sandwiching the dielectric layer, and external electrodes electrically connected to the internal electrode layers, respectively.

### FIELD

A certain aspect of the present disclosure relates to a multilayer ceramic electronic component and a dielectric ceramic composition.

### BACKGROUND

Multilayer ceramic electronic components such as multilayer ceramic capacitors (MLCCs) are used in high-frequency communication systems, such as mobile phones.

### PRIOR ART DOCUMENTS

### Patent Document

[Patent Document 1] Japanese Patent Application Publication No. 2002-087879

### SUMMARY OF THE INVENTION

In recent years, the use of multilayer ceramic electronic components has been expanding, even in electronic circuits affecting human life, such as in-vehicle electronic control devices. Because of this, high reliability is required and higher mass productivity is also required from the perspective of supply volume.

As the dielectric ceramic composition used for the dielectric layer of multilayer ceramic electronic components, a sintered body with a core-shell structure in which barium titanate is used as a core portion and a shell portion containing various additives as a solid dissolution surrounds the core portion has been used. By adopting this structure, due to the effects of the various additives, it is possible to shift exhibition of a large electrostatic capacity in the shell portion that would occur near the Curie temperature where barium titanate changes from the ferroelectric phase to the paraelectric phase, which exists around 125° C., to a lower temperature range, thereby making it possible to produce designs that have increased electrostatic capacity in the practical temperature range near room temperature.

It is believed that the core-shell structure is produced by solid-dissolving various additives in barium titanate. It is believed that the core-shell structure is produced by the reaction of various additives added to barium titanate particles, the main component, in the firing temperature range of, for example, 1000° C. to 1400° C. Generally, as the firing temperature increases, various additives dissolve into solid solution and the shell portion becomes thicker. Therefore, in order to keep the electrostatic capacity of the multilayer ceramic electronic component within the desired range, it is necessary to precisely control the solid dissolution of the additives.

For example, Patent Document 1 discloses a dielectric ceramic composition, a dielectric material, and a multilayer ceramic capacitor containing the same, which contain a barium titanate-based main component and subcomponents and in which, in XRD analysis after sintering, the relative intensity of the pyrochlore phase containing rare earth elements is controlled.

In recent years, the use of dielectric ceramic compositions and multilayer ceramic electronic components has expanded, resulting in a demand for higher mass productivity. To achieve this, it is necessary to suppress changes in electrostatic capacity due to firing temperature and reduce temperature-related electrostatic capacity fluctuations.

The present invention has been developed in consideration of the above-mentioned problems, and aims to provide a multilayer ceramic electronic component and a dielectric ceramic composition that suppress changes in electrostatic capacity due to firing temperature and have high reliability.

According to a first aspect of the embodiments, there is provided a multilayer ceramic electronic component including: a dielectric layer including first crystal grains and second crystal grains, the first crystal grains having a perovskite structure represented by a general formula ABO₃ and having a core portion containing molybdenum and a shell portion, the shell portion covering the core portion and containing a rare earth element and manganese, the second crystal grains including as a main component, a barium-titanate-based composite oxide having an elemental ratio of barium to titanium of 0.70 or less; internal electrode layers sandwiching the dielectric layer; and external electrodes electrically connected to the internal electrode layers, respectively.

In the above-mentioned multilayer ceramic component, an A site of the perovskite structure may include barium, and an element included at a B site of the perovskite structure may include at least one of titanium or zirconium.

In the above-mentioned multilayer ceramic component, the rare earth element may be at least one selected from a group consisting of lanthanum, cerium, praseodymium, neodymium, promethium, samarium, europium, gadolinium, terbium, dysprosium, holmium, erbium, and ytterbium.

In the above-mentioned multilayer ceramic component, an element at a B site of the perovskite structure may include titanium, and an elemental ratio of molybdenum to titanium of the first crystal grains may be 0.001 or more.

In the above-mentioned multilayer ceramic component, an elemental ratio of molybdenum to titanium of the second crystal grains may be less than 0.01.

In the above-mentioned multilayer ceramic component, the second crystal grains may include at least one selected from BaTi₄O₉, BaTi₅O₁₁, BaTi₆O₁₃, Ba₄Ti₁₁O₂₆, Ba₄Ti₁₂O₂₇, Ba₄Ti₁₃O₃₀, or Ba₆Ti₁₇O₄₀.

In the above-mentioned multilayer ceramic component, a maximum grain size of the first crystal grains may be 2 μm or less.

In the above-mentioned multilayer ceramic component, the shell portion may include magnesium and manganese.

According to a second aspect of the embodiments, there is provided a dielectric ceramic composition, including: first crystal grains having a perovskite structure represented by a general formula ABO₃, each first crystal grain having a core portion containing molybdenum and a shell portion, the shell portion covering the core portion and containing a rare earth element and manganese; and second crystal grains whose main component is a barium titanate-based composite oxide in which an elemental ratio of barium to titanium is 0.70 or less.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

FIG. 1 is a diagram illustrating a dielectric ceramic composition according to a first embodiment.

FIG. 2 is a diagram illustrating a unit cell.

FIG. 3 is a diagram illustrating a method for observing a core-shell structure.

FIG. 4 is a partial cross-sectional perspective view of a multilayer ceramic capacitor.

FIG. 5 is a cross-sectional view taken along a line A-A in FIG. 4.

FIG. 6 is a cross-sectional view taken along a line B-B in FIG. 4.

FIG. 7 is a diagram illustrating a flow of a manufacturing method for a multilayer ceramic capacitor.

FIG. 8A and FIG. 8B are diagrams illustrating an internal electrode formation process.

FIG. 9 is a diagram illustrating a crimping process.

FIG. 10 is a diagram illustrating a side margin portion.

### DETAILED DESCRIPTION

The following describes the embodiments with reference to the drawings.

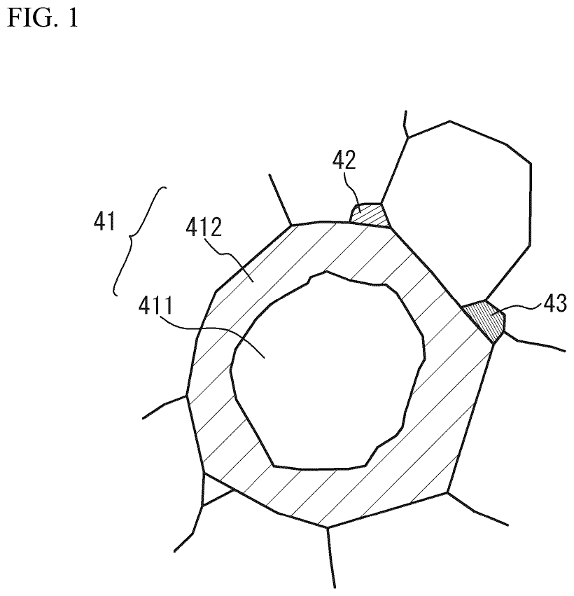

(First Embodiment) The dielectric ceramic composition according to the first embodiment is a ceramic polycrystalline body containing crystal grains with a perovskite structure represented by the general formula ABO₃, as illustrated in FIG. 1. Of these ceramic polycrystalline bodies, at least one is a first crystal grain 41 with a core-shell structure, and at least one is a second crystal grain 42 in which the elemental ratio of barium to titanium is 0.70 or less. Here, the elemental ratio refers to the ratio of the number of elements.

The first crystal grain 41 comprises a roughly spherical core portion 411 and a shell portion 412 that surrounds and covers the core portion 411. The core portion 411 is a crystalline portion in which the additive element is not solid-dissolved or in which the amount of the additive element is small. The shell portion 412 is a crystalline portion in which the additive element is solid-dissolved and has a higher additive element concentration than the core portion 411. Therefore, the additive element solid-dissolved in the core portion 411 is solid-dissolved at a higher elemental concentration in the shell portion 412 than in the core portion 411. The element solid-dissolved in the shell portion 412 is not solid-dissolved in the core portion 411 or is solid-dissolved at a lower elemental concentration than in the shell portion 412.

In this embodiment, in the first crystal grain 41, the core portion 411 contains molybdenum (Mo), and the shell portion 412 contains a rare earth element R and manganese. Furthermore, the dielectric ceramic composition includes the second crystal grain 42 in which the elemental ratio of barium to titanium is 0.70 or less. With this configuration, molybdenum, which functions as a donor, is contained even in the core portion 411, thereby improving the reliability of the dielectric ceramic composition. The inclusion of the rare earth element R and manganese in the shell portion 412 suppresses the range of change in electrostatic capacity due to changes in firing temperature and further suppresses the migration of oxygen vacancies on the grain boundaries and in the shell portion 412, further improving reliability. Furthermore, the inclusion of the second crystal grain 42 in the dielectric ceramic composition, in which the elemental ratio of barium to titanium is 0.70 or less, prevents excessive crystal grain growth during firing, thereby suppressing the change in electrostatic capacity due to changes in firing temperature. As a result, the dielectric ceramic composition according to this embodiment is highly reliable and can suppress changes in electrostatic capacity due to firing temperature. Oxygen vacancies are also sometimes referred to as oxide ion vacancies or oxygen ion defects.

The rare earth element R in the shell portion 412 is not particularly limited, but may be at least one selected from the group consisting of lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), and ytterbium (Yb). The elemental concentration of the rare earth element R in the shell portion 412 is greater than the elemental concentration of the rare earth element R in the core portion 411.

For example, when a cross section of the dielectric ceramic composition is observed in a field where a total of 100 or more of the first crystal grains 41 and the second crystal grains 42 can be confirmed, the area ratio of the first crystal grains 41 is 95% or more and 99.95% or less, and the area ratio of the second crystal grains 42 is 0.01% or more and 5% or less.

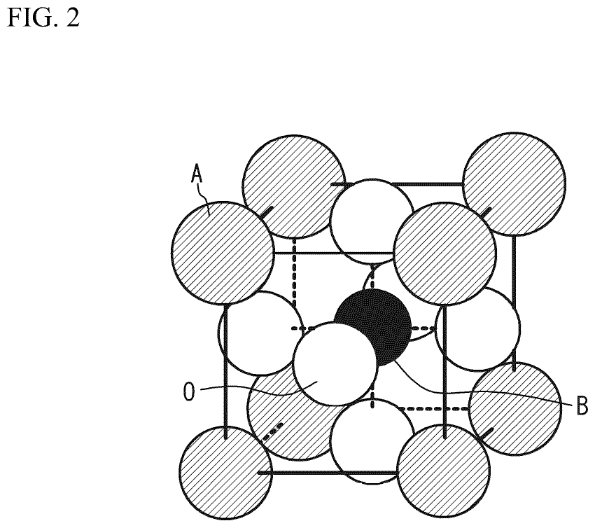

Crystal grains having a perovskite structure, which are the main components of the first crystal grains 41, have a unit cell as illustrated in FIG. 2. This unit cell has the A site located at the apex of the lattice, the O site located at the face center of the lattice, and the B site located within an octahedron with the O site as the apex. In the perovskite structure, alkaline earth metals that can take divalent cations such as barium (Ba), strontium (Sr), and calcium (Ca) are located at the A site. Metal atoms that can take on tetravalent cations, such as hafnium (Hf), zirconium (Zr), and titanium (Ti) are located at the B site.

The perovskite structure also allows a composition formula that deviates from the stoichiometric composition. That is, the ratio of the A-site element to the B-site element does not necessarily have to be 1:1, and defects may be generated within a range where the perovskite structure can be maintained. Furthermore, defects may also be generated regarding oxygen. For example, when the composition formula is A_{α}BO_{3-β}, compositions in the ranges of 0.98≤α≤1.01 and 0≤β≤0.20 are allowed.

However, for example, the generation of oxygen vacancies may reduce resistivity or exhibit ionic conductivity, which may shorten the electrical life of multilayer ceramic capacitors and increase dielectric loss, making them unusable for practical use. Therefore, by solid-dissolving molybdenum into the first crystal grain 41, which has a perovskite structure, electrical life can be effectively extended. In particular, in this embodiment, the inclusion of molybdenum in the core portion 411 effectively extends electrical life. To fully utilize the effects of molybdenum, the molybdenum-to-titanium elemental ratio throughout the entire first crystal grain 41 is preferably 0.001 or greater.

Furthermore, the first crystal grain 41 may optionally contain at least one of second transition elements: yttrium (Y), zirconium (Zr), niobium (Nb), ruthenium (Ru), rhodium (Rh), palladium (Pd), and silver (Ag). This allows for improved resistivity, increased electrical life, and reduced dielectric loss relative to electrostatic capacity.

Furthermore, the first crystal grain 41 may optionally contain at least one of third transition elements: lanthanum (La), cerium (Ce), praseodymium (Pr), neodymium (Nd), samarium (Sm), europium (Eu), gadolinium (Gd), terbium (Tb), dysprosium (Dy), holmium (Ho), erbium (Er), thulium (Tm), ytterbium (Yb), lutetium (Lu), hafnium (Hf), tantalum (Ta), tungsten (W), rhenium (Re), osmium (Os), iridium (Ir), platinum (Pt), and gold (Au). This allows for improved resistivity, increased electrical life, and reduced dielectric loss relative to electrostatic capacity.

The dielectric ceramic composition preferably contains an additive containing the rare earth element R, such as lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), or ytterbium (Yb). The dielectric ceramic composition also preferably contains an additive containing titanium so that the elemental ratio (ratio of the number of elements) of titanium to the rare earth element R is 1 or greater. Compared to when no additive containing titanium is added, the solid-solution reaction with barium titanate crystal grains is relatively suppressed. This effect enables shorter firing times while suppressing the rate of change in electrostatic capacity due to changes in firing temperature, enabling high mass productivity.

Preferred additive containing the rare earth element R is such as lanthanum oxide (La₂O₃), cerium oxide (Ce₂O₃), praseodymium oxide (Pr₂O₃), neodymium oxide (Nd₂O₃), promethium oxide (Pm₂O₃), samarium oxide (Sm₂O₃), europium oxide (Eu₂O₃), gadolinium oxide (Gd₂O₃), terbium oxide (Tb₂O₃), dysprosium oxide (Dy₂O₃), holmium oxide (Ho₂O₃), erbium oxide (Er₂O₃), or ytterbium oxide (Yb₂O₃).

A preferred example of the titanium-containing additive is titanium oxide, but other suitable additives are such as titanium hydroxide (Ti(OH)₄), titanium chloride (TiCl₄), titanium carbide (TiC), or titanium sulfide (TiS₂).

The additive containing the rare earth element R and titanium is such as La₂ Ti₂O₇, Ce₂Ti₂O₇, Pr₂Ti₂O₇, Nd₂Ti₂O₇, Pm₂Ti₂O₇, Sm₂Ti₂O₇, Eu₂ Ti₂O₇, Gd₂Ti₂O₇, Tb₂Ti₂O₇, Dy₂Ti₂O₇, Ho₂Ti₂O₇, Er₂Ti₂O₇, or Yb₂Ti₂O₇.

In addition to adding the rare earth element R, it is preferable to add 0.2 mol or more and 5.0 mol or less of manganese oxide (MnO) to 100 mol of barium titanate so that the Mn/Ti element ratio z, which is the manganese elemental ratio to the titanium content, satisfies 0.002≤z≤0.05.

In the core-shell structure, generally, as the firing temperature increases, various additives tend to solid-dissolve more in the barium titanate crystal grains, resulting in a thicker shell portion. In the shell portion, the high electrostatic capacity range near 125° C., which is near the Curie temperature of barium titanate, gets closer to room temperature. As a result, the electrostatic capacity in the practical temperature range near room temperature varies significantly depending on the thickness of the shell portion. Therefore, for example, to keep the electrostatic capacity of a multilayer ceramic capacitor within the desired range, it is preferable to precisely control the firing temperature.

For example, the dielectric ceramic composition of this embodiment can be obtained by maintaining a temperature between 900° C. and 1100° C., then firing at 1150° C. to 1300° C., and rapidly increasing the temperature during the firing process at a rate of 3000° C./h to 10,000° C./h.

The first crystal grain 41, which has the core-shell structure and the shell portion 412 containing the rare earth element R, is formed through a process different from conventional core-shell structures. Specifically, not only is the rare earth element R solid-dissolved in the barium titanate crystal grain, but the added rare earth element R and titanium first form a compound with a pyrochlore structure or perovskite slab structure, such as R₂Ti₂O₇, which then reacts with the surface of the barium titanate crystal grain to form a composite perovskite compound, such as R(Ti,Mn)O₃, as the shell portion 412. This prevents excessive solid-dissolution of the rare earth element R or the like in the shell portion 412, thereby reducing the rate of change in electrostatic capacity due to changes in firing temperature. As a trace of the shell portion 412 formation process, an oxide region with a higher concentration of the rare earth element R than the shell portion is formed. The R₂T₁₂O₇ formation reaction occurs between 900° C. and 1100° C.

To promote this shell formation reaction, it is desirable for the rare earth element R to be an element that easily solid-dissolves in the A site of ABO₃. Specifically, rare earth element with a larger ionic radius than erbium (Er) such as lanthanum (La), cerium (Ce), praseodymium (Pr), neodymium (Nd), promethium (Pm), samarium (Sm), europium (Eu), gadolinium (Gd), terbium (Tb), dysprosium (Dy), or holmium (Ho) is preferred.

On the other hand, using the rare earth element R(erbium, thulium, ytterbium, ruthenium) with an ionic radius smaller than that of holmium produces a pyrochlore structure compound R₂Ti₂O₇, but the shell-forming reaction between R₂Ti₂O₇ and the barium titanate crystal grain may not proceed sufficiently, potentially resulting in electrical contact between the cores of multiple grains and the oxide region. This results in a decrease in resistivity, making the resulting product unsuitable for use in multilayer ceramic capacitors.

The shell portion 412 may also contain magnesium, which reacts with the surface of the barium titanate crystal grain to produce a shell portion of a composite perovskite compound such as R(Mg,Ti,Mn)O₃.

The composite perovskite compound, thought to be R(Ti,Mn)O₃ or R(Mg,Ti,Mn)O₃, may react with the surrounding barium titanate crystal grains, which are the main component, to form the shell portion 412 as (R,Ba)(Ti,Mn)O₃ or (R,Ba)(Mg,Ti,Mn)O₃.

For example, the core portion 411 in the core-shell structure is primarily composed of barium titanate crystal grain, but may also contain the added rare earth element R, manganese, or magnesium. However, it is sufficient if the shell portion 412 contains relatively more of the added rare earth element R, manganese, and magnesium than the core portion 411.

More specifically, the crystal grain with the core-shell structure, primarily composed of barium titanate crystal grain and the shell portion containing the rare earth element and manganese, may contain a relatively high amount of the rare earth element or manganese relative to the titanium content at the center at any point within a range of 10% of the diameter of the crystal grain from the surface toward the center. The presence of such core-shell crystal grain not only reduces the range of change in electrostatic capacity due to changes in firing temperature, but also inhibits the migration of oxygen vacancies on the grain boundaries and within the shell portion, thereby preventing a decrease in resistivity and improving electrical life.

The average grain size of the first crystal grains 41 in the dielectric ceramic composition is within the range of 50 nm to 500 nm, and large grains of 3 μm or larger are not retained in a portion that is electrically utilized as a dielectric. For example, in the dielectric ceramic composition, the maximum grain size of the first crystal grains 41 is preferably 2 μm or less. Given the general characteristic of ceramics, in which the grain size and composition distribution of the contained crystal grains falls within a relatively narrow range, if it can be confirmed that the first crystal grain 41 has the core-shell structure, the presence of the numerous first crystal grains 41 with a similar structure can be said to have a positive effect on the electrical life of the dielectric ceramic composition.

The grain size of the first crystal grain 41 can be measured using the following procedure. The dielectric ceramic composition containing the first crystal grain 41 is cut or polished to expose the observation surface. This exposure method is not particularly limited, and methods such as cutting or polishing an element can be used. To fully observe the internal ceramic structure, it is preferable to use a diamond paste of 2 μm or less to achieve a smoothness that can be considered a mirror surface. Next, a conductive material such as platinum or osmium is vapor-deposited onto the observation surface, and the surface is observed with a scanning electron microscope (SEM) to take a photograph of the first crystal grain 41. Next, multiple parallel lines are drawn in the photograph, and the length of each line segment cut at the periphery of each of the first crystal grains 41 (the distance between the two points where each line intersects with the periphery of the first crystal grain 41) is taken as the grain diameter (grain size) of the first crystal grain 41. Using this method, the grain size of 400 or more of the first crystal grains 41 is measured, and the average of the results is taken as the average grain size of the first crystal grains 41. Furthermore, if the outlines of the first crystal grain 41 are difficult to see in the exposed ceramic, it is recommended to subject the exposed ceramic to heat treatment (thermal etching) for approximately 5 minutes at a temperature approximately 50° C. lower than the firing temperature prior to vapor deposition of platinum, osmium, or the like. Instead of this heat treatment, chemical etching can also be performed using an acid such as hydrofluoric acid, hydrochloric acid, sulfuric acid, nitric acid, or a mixture of these acids at an appropriate concentration for etching.

The presence of the first crystal grain 41 with the core-shell structure in the dielectric ceramic composition can be confirmed by the following procedure. Note that the following procedure describes the case where gadolinium is used as the rare earth element as an example.

First, a sample for observation with a transmission electron microscope (TEM) is cut from the dielectric ceramic composition to be confirmed. This cutting can be performed using a focused ion beam (FIB) device or the like.

Next, the cut-out sample for TEM observation is observed using a TEM equipped with an energy dispersive X-ray spectrometry (EDS) or wavelength dispersive X-ray spectrometry (WDS) to determine the crystal grains to be measured and identify the outer circumferential shape of those grains.

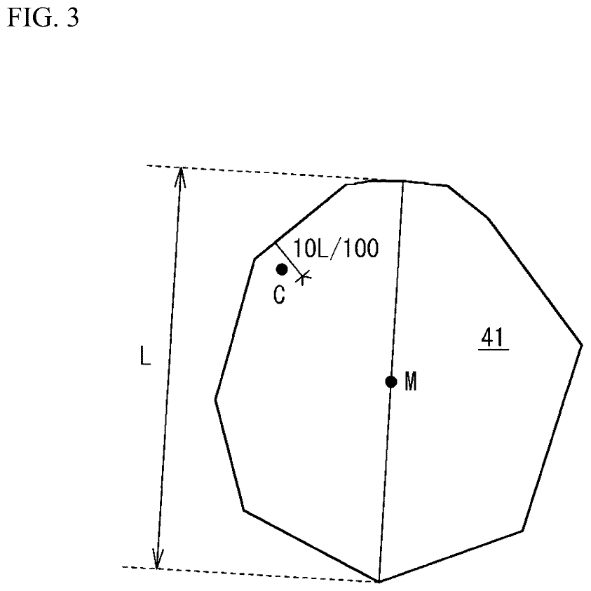

Next, as illustrated in FIG. 3, the longest line segment connecting any two points located on the periphery of the crystal grain being measured is determined, and the length L of that line segment is measured. This length L is then used as the diameter of the crystal grain being measured. The midpoint M of the line segment is then determined from the length of the resulting line segment.

For any point C on the periphery within a range of 10% of the diameter of the crystal grain from either end of the line segment, composition analysis is performed using EDS or WDS to calculate the abundance ratio of the element being analyzed to titanium. In the composition analysis, for example, in EDS measurement, the element is identified simply by the titanium K-ray intensity relative to the barium K-ray or L-ray, gadolinium L-ray, manganese K-ray, and molybdenum K-ray. More specifically, these intensities are subjected to correction (ZAF correction) taking into account atomic number effects, absorption effects, and fluorescence excitation effects, to calculate the ratio of each element relative to the titanium element content, which is defined as the ratio of each element to titanium in the shell portion 412. Furthermore, a similar composition analysis is performed at the midpoint M of the line segment to calculate the ratio, which is defined as the ratio of each element to titanium in the core portion 411.

Next, the ratio of each element to titanium in the shell portion 412 is compared with the ratio of each element to titanium in the core portion 411, and if the ratio in the shell portion 412 is higher than that in the core portion 411, it is determined that the first crystal grain 41 being measured has the core-shell structure.

As described above, in addition to the first crystal grain 41, the dielectric ceramic composition contains at least one crystal grain made of a barium titanate-based composite oxide having a barium to titanium elemental ratio of 0.70 or less, as the second crystal grain 42 other than the first crystal grain 41.

In the second crystal grain 42, the elemental ratio of barium to titanium is preferably 0.16 or greater. The second crystal grain 42 may also contain manganese. The elemental ratio of manganese to titanium in the second crystal grain may be 0.02 or greater and 0.10 or less, or may be 0.02 or greater and 0.05 or less.

A more preferred example of the second crystal grain 42 is a barium titanate-based composite oxide, such as Ba₄Ti₁₁O₂₆, which is a monoclinic crystal system with a space group of C2/m and lattice constants of a=15.160 Å, b=3.893 Å, c=9.093 Å, and β=98.6°. This barium titanate-based composite oxide has a barium-to-titanium elemental ratio relatively close to 3, making it easy to intentionally precipitate without using large amounts of additives primarily composed of titanium.

A more preferred example of the second crystal grain 42 is one in which magnesium, manganese, and nickel are solid-dissolved in Ba₄Ti₁₁O₂₆, desirably occupying the vacancy site or substituting for some of titanium. Ba₄Ti₁₁O₂₆ has a crystal structure in which vacancies occur in some of the titanium sites. For this reason, titanium is likely to change from tetravalent cations to trivalent cations at the vacancy sites, resulting in a decrease in resistivity. To compensate for this, it is effective to have at least one of magnesium, manganese, and nickel in solid solution.

A more suitable example of the second crystal grain 42 is one in which the amount of molybdenum solid-dissolved in Ba₄Ti₁₁O₂₆ is low. Because molybdenum ions tend to be stable at tetravalent or hexavalent valences, when molybdenum is solid-dissolved in Ba₄Ti₁₁O₂₆, it is likely that titanium will change from tetravalent cations to trivalent cations, resulting in a decrease in resistivity. For example, in the second crystal grain 42, the molybdenum to titanium elemental ratio is preferably less than 0.01.

As is clear from its compositional formula, the second crystal grain 42 is a barium titanate composite oxide in which the elemental ratio of barium is lower than that of titanium. The crystal grain is generated as by-product when a titanium-based additive is used to form the shell portion described above. Other examples of the second crystal grain 42 include at least one selected from BaTi₄O₉, BaTi₅O₁₁, BaTi₆O₁₃, Ba₄Ti₁₁O₂₆, Ba₄Ti₁₂O₂₇, Ba₄Ti₁₃O₃₀, and Ba₆Ti₁₇O₄₀.

The presence of the second crystal grain 42 in the dielectric ceramic composition can be confirmed by the following procedure.

First, the diffraction line profile of the surface of the dielectric ceramic composition to be confirmed, or of the powder obtained by pulverizing the dielectric ceramic composition, is measured using an X-ray diffractometer (XRD) using Cu-Kα ray. The pulverization method for obtaining the powder is not particularly limited, and a hand mill (mortar and pestle) or the like can be used. Furthermore, when measuring the diffraction line profile of ceramics constituting a multilayer ceramic capacitor, the electrodes and coating formed on the surface of the element, as well as areas other than the dielectric layer of the multilayer ceramic capacitor, are removed to expose the surface of the dielectric ceramic composition. This exposure method is not particularly limited, and methods such as cutting or polishing the element can be used. Furthermore, when measuring the diffraction line profile of powder of a dielectric ceramic composition constituting a multilayer ceramic capacitor, it is more preferable to remove the electrodes and coating formed on the element, as well as areas other than the dielectric layer of the multilayer ceramic capacitor, before pulverization.

Next, the percentage of the strongest diffraction line intensity in the diffraction profile derived from other structures relative to the strongest diffraction line intensity in the profile derived from the perovskite structure is calculated for the obtained diffraction line profile. If this percentage is 10% or less, the dielectric ceramic composition being confirmed is determined to be composed of the first crystal grains 41 having a perovskite structure. Note that when the surface of the dielectric ceramic composition of the multilayer ceramic capacitor is exposed using the above method, or when XRD measurement is performed on pulverized powder, peaks from the materials constituting the electrodes and coating may also be detected. These peaks are then excluded before calculating the above-mentioned diffraction intensity ratio.

Next, the crystalline phase is identified by focusing on peaks other than the diffraction intensity in the profile derived from the perovskite structure. To identify the crystalline phase, it is desirable to search the PDF (Powder Diffraction File) published by the ICDD (International Centre for Diffraction Data; Pennsylvania, USA) to determine whether the composition contains the second crystal grain 42. In the case of Ba₄Ti₁₁O₂₆, a suitable example, its formation can be evaluated by identifying it with reference to PDF-01-083-1459.

Next, the fact that the second crystal grain 42 is made of a barium titanate composite oxide in which the elemental ratio of barium to titanium is 0.70 or less and the elemental ratio of molybdenum to titanium is 0.01 or less can be confirmed using a method similar to that used to confirm the presence of the first crystal grain 41 having the core-shell structure.

Furthermore, as illustrated in FIG. 1, the dielectric ceramic composition may contain a crystal grain 43 having a different composition or crystal structure from the first crystal grain 41 and the second crystal grain 42. The dielectric ceramic composition may also contain a silicon-containing crystal grain or a glass grain. This allows the dielectric ceramic composition to be sufficiently densified by firing at 1300° C. or less.

A typical example of the crystal grain 43 is such as silicate (SiO₂), enstatite (MgSiO₃), barium magnesium silicate (BaMgSiO₄), or fresnoite (Ba₂TiSi₂O₈), or a glass grain.

Other examples of the crystal grain 43 include secondary compounds derived from added substances or electrodes, such as geikelite (MgTiO₃), manganese nickel oxide ((Mn,Ni)O), and pyrophanite (MnTiO₃).

(Second embodiment) As a second embodiment, a multilayer ceramic capacitor 100 using the dielectric ceramic composition according to the first embodiment will be described.

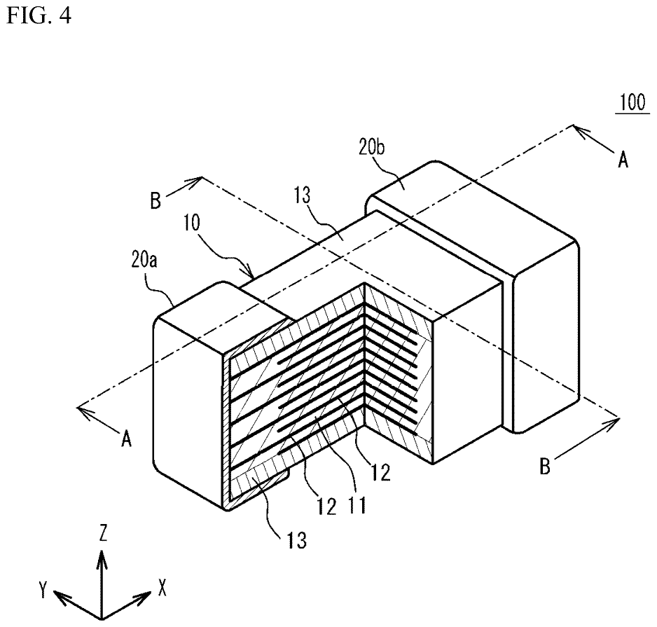

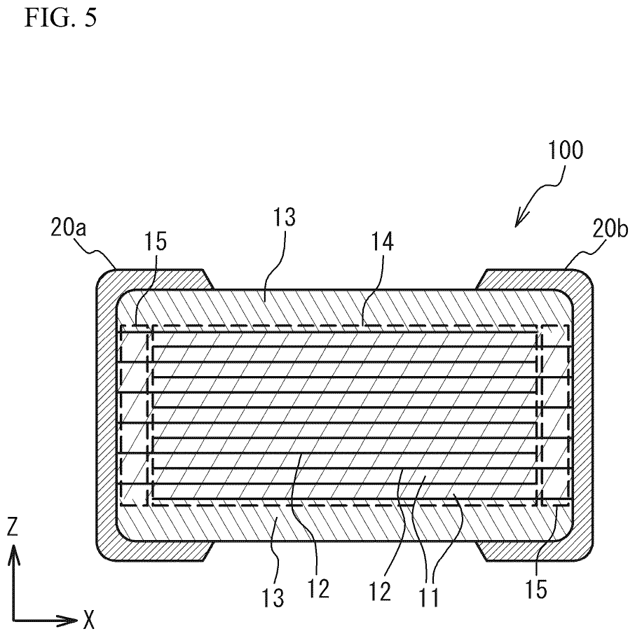

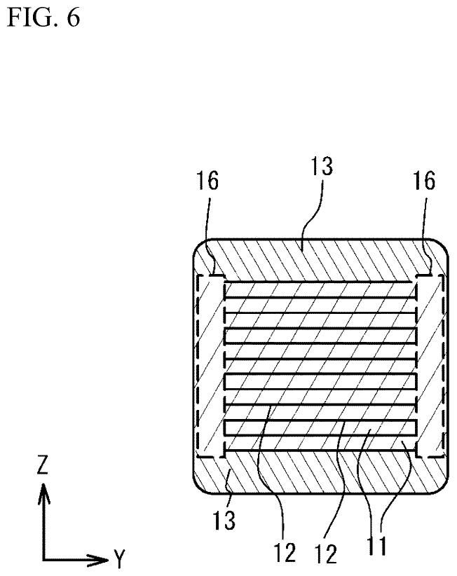

FIG. 4 is a partially cross-sectional perspective view of the multilayer ceramic capacitor 100. FIG. 5 is a cross-sectional view taken along the line A-A in FIG. 4. FIG. 6 is a cross-sectional view taken along the line B-B in FIG. 4. As illustrated in FIG. 4 to FIG. 6, the multilayer ceramic capacitor 100 includes a multilayer chip 10 having a substantially rectangular parallelepiped shape, and external electrodes 20a and 20b provided on two opposing end surfaces of the multilayer chip 10. Note that, of the four surfaces of the multilayer chip 10 other than the two end surfaces, two surfaces other than the upper surface and the lower surface in the stacking direction are referred to as side surfaces. The external electrodes 20a and 20b extend on the top surface, bottom surface, and two side surfaces of the stacked chip 10 in the stacking direction. However, the external electrodes 20a and 20b are spaced apart from each other.

The multilayer chip 10 has a structure in which dielectric layers 11 containing the dielectric ceramic composition and internal electrode layers 12 containing a base metal material are alternately laminated. The edges of the internal electrode layers 12 are exposed alternately on the end surface where the external electrode 20a of the multilayer chip 10 is provided and the end surface where the external electrode 20b is provided. Thereby, the respective internal electrode layers 12 are alternately electrically connected to the external electrodes 20a and 20b. As a result, multilayer ceramic capacitor 100 has a structure in which the plurality of dielectric layers 11 are stacked with the internal electrode layers 12 in between. Further, in the laminate of the dielectric layer 11 and the internal electrode layer 12, the internal electrode layer 12 is disposed as the outermost layer in the stacking direction, and the top and bottom surfaces of the laminate are each covered with cover layers 13. The cover layer 13 has a ceramic material as a main component. For example, the cover layer 13 has the same ceramic main component as the dielectric layer 11.

The size of the multilayer ceramic capacitor 100 is, for example, 0.25 mm long, 0.125 mm wide, and 0.125 mm high, or 0.4 mm long, 0.2 mm wide, and 0.2 mm high, or 0.6 mm long, 0.3 mm wide, and 0.3 mm high, or 1.0 mm long, 0.5 mm wide, and 0.5 mm high, or 3.2 mm long, 1.6 mm wide, and 1.6 mm high, or 4.5 mm high, 3.2 mm side, and 2.5 mm high, but the size is not limited to these.

The internal electrode layer 12 has a base metal such as Ni (nickel), Cu (copper), Sn (tin) as a main component. As the internal electrode layer 12, noble metals such as Pt (platinum), Pd (palladium), Ag (silver), or Au (gold), or alloys containing these metals may be used.

As illustrated in FIG. 5, the section where the internal electrode layer 12 connected to the external electrode 20a and the internal electrode layer 12 connected to the external electrode 20b face each other is a section in which capacitance occurs in the multilayer ceramic capacitor 100. Therefore, the section where the electric capacitance occurs is referred to as a capacitance section 14. That is, the capacitance section 14 is a region where adjacent internal electrode layers 12 connected to different external electrodes face each other.

The section where the internal electrode layers 12 connected to the external electrode 20a face each other without interposing the internal electrode layer 12 connected to the external electrode 20b is referred to as an end margin 15. Further, another end margin 15 is also a section where the internal electrode layers 12 connected to the external electrode 20b face each other without interposing the internal electrode layer 12 connected to the external electrode 20a. That is, the end margin 15 is a section where the internal electrode layers 12 connected to the same external electrode face each other without interposing the internal electrode layers 12 connected to the other external electrode. The end margin 15 is a section where no capacitance occurs.

As illustrated in FIG. 5, in the multilayer chip 10, the section from the two side surfaces of the multilayer chip 10 reaching the internal electrode layer 12 is referred to as a side margin 16. That is, the side margin 16 is a section provided so as to cover the side ends of the plurality of stacked internal electrode layers 12 extending toward one of the two side surfaces in the stacked structure. The side margin 16 is also a section that does not generate capacitance.

In the multilayer ceramic capacitor 100 according to this embodiment, at least a portion of the dielectric layer 11 in the capacitance section 14 contains the first crystal grain 41 illustrated in FIG. 1, as well as the second crystal grain 42. This suppresses changes in electrostatic capacity due to firing temperature and improves insulation properties over a wide range of firing atmospheres. As a result, high mass productivity is possible. High reliability is also achieved.

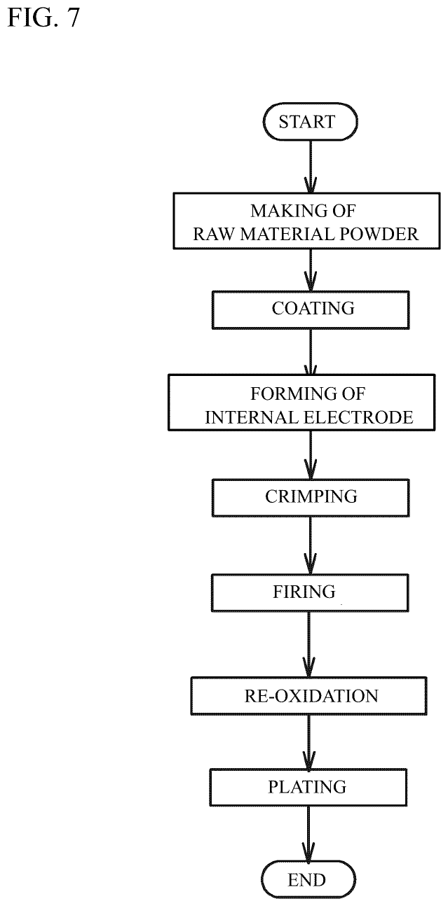

Next, a method for manufacturing the multilayer ceramic capacitor 100 will be described. FIG. 7 is a diagram illustrating a flow of a method for manufacturing the multilayer ceramic capacitor 100.

(Raw material powder production process) First, a dielectric ceramic composition for forming the dielectric layers 11 is prepared. The A-site element and the B-site element contained in the dielectric layer 11 are usually contained in the dielectric layer 11 in the form of a sintered body of ABO₃ particles. For example, barium titanate is a compound that has a perovskite structure and belongs to the tetragonal system near room temperature, and exhibits a high dielectric constant. This barium titanate can generally be synthesized by reacting a titanium raw material such as titanium dioxide with a barium raw material such as barium carbonate. Various methods are conventionally known for synthesizing barium titanate, which is the main component of the dielectric layer 11, such as a solid phase method, a sol-gel method, and a hydrothermal method. In this embodiment, any of these can be adopted.

In this embodiment, when synthesizing barium titanate, 0.01 mol or more and 0.1 mol or less of molybdenum oxide (in terms of molybdenum) is added to 100 mol of barium titanate. Adding molybdenum during barium titanate synthesis allows Mo to be solid-dissolved throughout the core, thereby improving reliability.

Specified additives are added to the molybdenum-doped barium titanate powder obtained by the above method. In order to form the core-shell structure, it is preferable to add manganese and the rare earth element, in particular, after synthesizing the molybdenum-doped barium titanate powder. As an example, the additive within the ranges described in the example of the dielectric ceramic composition according to the first embodiment are used. If necessary, oxides or glasses containing zirconium (Zr), vanadium (V), chromium (Cr), cobalt (Co), nickel (Ni), lithium (Li), boron (B), sodium (Na), or potassium (K) may also be used.

For example, a compound containing an additive compound is wet-mixed with molybdenum-doped barium titanate powder, followed by drying and pulverization to prepare a ceramic material containing the molybdenum-doped barium titanate powder and the additive compound. For example, the ceramic material obtained as described above may be pulverized as needed to adjust the particle size, or may be combined with a classification process to regulate the particle size. Specifically, the particle size can be adjusted by stirring the ceramic material with beads of 0.1 mm to 3 mm in diameter, such as yttrium-stabilized zirconia, alumina, or silicon nitride, for 10 to 100 hours. The dielectric ceramic composition is obtained through the above process.

(Coating process) Next, a binder such as polyvinyl butyral (PVB) resin, an organic solvent such as ethanol or toluene, and a plasticizer are added to the obtained dielectric ceramic composition and wet-mixed. Using the obtained slurry, a ceramic green sheet 51 is coated on a base material by, for example, a die coater method or a doctor blade method, and then dried. The base material is, for example, a polyethylene terephthalate (PET) film. Figures illustrating the coating process are omitted.

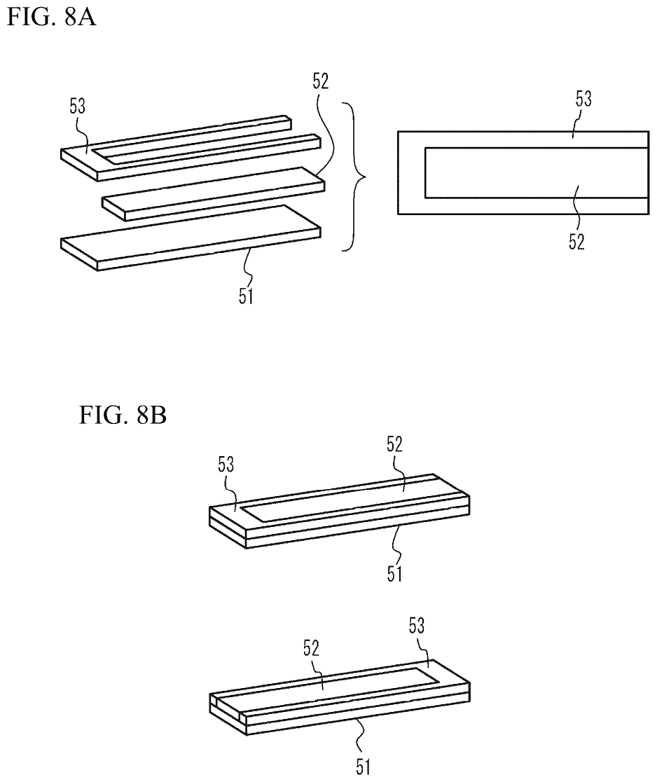

(Internal electrode formation process) Next, as illustrated in FIG. 8A, a metal conductive paste containing an organic binder for forming internal electrodes is printed on the surface of the ceramic green sheet 51 by screen printing, gravure printing or the like, to form internal electrode patterns 52 that are to be arranged alternately to a pair of external electrodes. Ceramic particles are added to the metal conductive paste as a co-material. Although the main component of the ceramic particles is not particularly limited, it is preferably the same as the main component ceramic of the dielectric layer 11. For example, barium titanate having an average particle diameter of 50 nm or less may be uniformly dispersed.

Next, a binder such as ethyl cellulose and an organic solvent such as terpineol are added to the dielectric ceramic composition obtained in the raw material powder manufacturing process, and the mixture is kneaded in a roll mill to form a dielectric pattern paste for the reverse pattern layer. As illustrated in FIG. 8A, on the ceramic green sheet 51, a dielectric pattern 53 is arranged by printing a dielectric pattern paste in the peripheral area where the internal electrode pattern 52 is not printed so as to arrange the internal electrode pattern 52, thereby filling in a step with the internal electrode pattern 52. The ceramic green sheet 51 on which the internal electrode pattern 52 and the dielectric pattern 53 are printed is referred to as a stack unit.

Thereafter, as illustrated in FIG. 8B, the stack units are stacked such that the internal electrode layers 12 and the dielectric layers 11 are arranged alternately, and that the edges of the internal electrode layers 12 are alternately exposed and drawn out alternately to a pair of external electrodes 20a and 20b having different polarities. For example, the number of stacked layers of the internal electrode pattern 52 is set to 100 to 1000 layers.

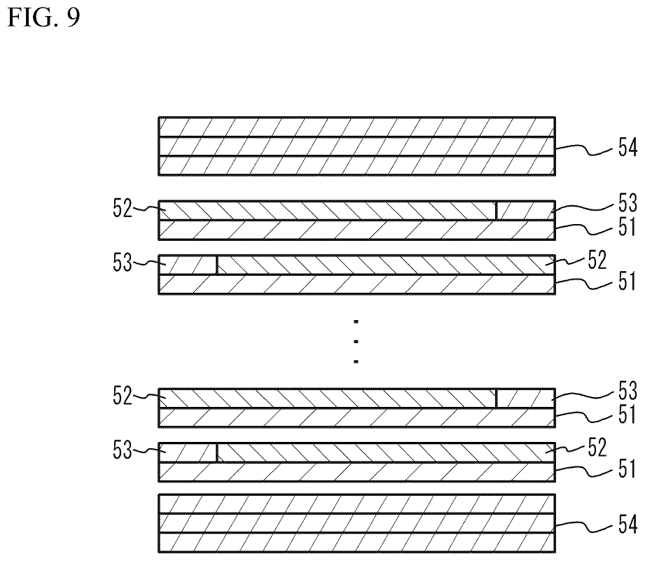

(Crimping process) As illustrated in FIG. 9, a predetermined number (for example, 2 to 10 layers) of cover sheets 54 are laminated on top and bottom of the laminate, in which the lamination units have been laminated, and are bonded by thermocompression. As an example of the ceramic material for the cover sheet 54, the dielectric ceramic composition described above can be used. Thereafter, it is cut into a predetermined chip size (for example, 1.0 mm×0.5 mm).

(Firing process) After de-binding the ceramic multilayer body thus obtained in an N₂ atmosphere, air atmosphere, or the like, a metal paste that will become the base layer of the external electrodes 20a, 20b is applied by a dip method, and the resulting laminate is fired at 1150° C. to 1300° C. for 10 minutes to 2 hours, after keeping the temperature at 800° C. to 1100° C. for 10 minutes to 1 hour in a reducing atmosphere with an oxygen partial pressure of 10-10 to 10-7 atm.

(Re-oxidation treatment process) Thereafter, reoxidation treatment may be performed at 600° C. to 1000° C. in an N₂ gas atmosphere.

(Plating process) Thereafter, a metal coating such as Cu, Ni, Sn and so on is performed on the base layer of the external electrodes 20a, 20b by plating. Through the above steps, the multilayer ceramic capacitor 100 is completed.

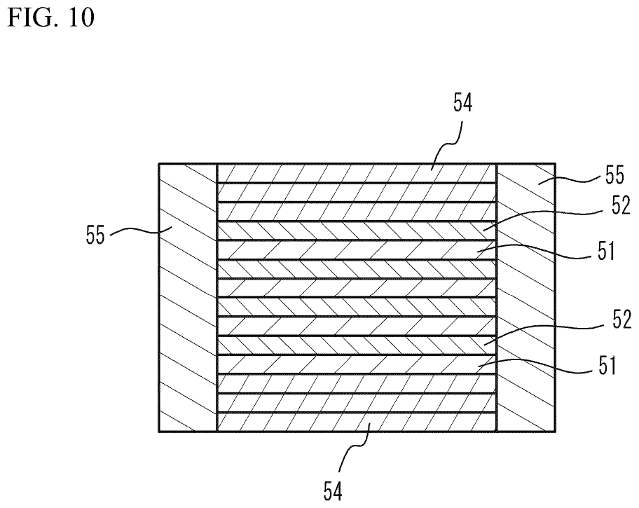

The side margin portion may be attached or applied to the side surfaces of the laminated portion. Specifically, as illustrated in FIG. 10, the laminated portion is obtained by alternately stacking the ceramic green sheets 51 and the internal electrode patterns 52 of the same width as the ceramic green sheets 51. Next, a sheet formed from the dielectric pattern paste may be attached to the side surfaces of the laminated portion as a side margin portion 55.

In the manufacturing method according to this embodiment, the added rare earth element R and titanium form R₂Ti₂O₇, a compound with a pyrochlore structure or perovskite slab structure, by maintaining the temperature at 800 to 1100° C. for 10 minutes to 1 hour in a reducing atmosphere with an oxygen partial pressure of 10-10 to 10-7 atm. When the temperature is then raised to 1100 to 1300° C., the compound reacts with the surface of the barium titanate crystal grain, forming the shell portion 412 in the form of a composite perovskite compound, such as R(Ti,Mn)O₃. Furthermore, when the temperature is raised from 1100 to 1300° C., the rate of temperature increase is increased from 3000° C./h to 10000° C./h, thereby forming the second crystal grains 42. This suppresses changes in electrostatic capacity due to firing temperature, enabling high mass productivity.

The firing temperature dependence (Δε/° C.) of the relative dielectric constant of the multilayer ceramic capacitor 100 due to changes in firing temperature is determined using the following method. First, the electrostatic capacity Cp (nF) and DC current I (nA) are measured for the multilayer ceramic capacitor 100 that has undergone the firing, the re-oxidation, and the plating processes. Next, the capacitance section 14 of the multilayer ceramic capacitor 100 is exposed by cutting or polishing the cross sections along the lines A-A and B-B illustrated in FIG. 5 and FIG. 6. Finally, the effective area of the internal electrode layers is calculated using a diamond paste of 2 μm or less to achieve a smoothness that can be considered a mirror finish.

The effective area S is calculated from the length L and the number N of layers of the internal electrode layers 12 in the capacitance section 14 in FIG. 5, and the width W of the internal electrode layers 12 in the capacitance section 14 in FIG. 6, according to S=L×W×(N−1).

The thickness of each of the dielectric layers 11 is also measured, and the average thickness t is calculated. The relative dielectric constant ε can be calculated according to ε=(Cp×t/S)/ε0, where ε₀ is the dielectric constant of a vacuum: ε₀=8.8542×10⁻¹² F/m.

The DC resistivity ρ (Ω·cm) can be calculated according to ρ=(V/I)×(S/t), where V (V) is the DC voltage used during measurement.

It is generally preferable to measure the electrostatic capacity Cp using an LCR meter. When measuring, it is necessary to determine the measurement frequency and measurement voltage, and the measurement voltage is preferably determined as a measurement electric field that depends on the thickness of the dielectric layer 11. In this embodiment, the electrostatic capacity Cp can be measured at a room temperature of 25° C., with a measurement frequency of 1 kHz and a measurement electric field of 0.5 Vrms/μm. In other words, if the thickness of the dielectric layer 11 is 2 μm, the measurement voltage is 1 Vrms.

It is generally preferable to measure DC current I using an insulation resistance meter. When measuring, it is necessary to determine the measurement voltage, and the measurement electric field is preferably determined as a measurement electric field that depends on the thickness of the dielectric layer 11. In this embodiment, the multilayer ceramic capacitor 100 is placed in a 150° C. thermostatic chamber for 30 minutes, with insulation from the surroundings secured using ceramic insulators or the like. A measurement electric field of 30 V/μm (for example, 60 V for 30 seconds if the dielectric layer 11 is 2 μm thick) is applied from the thermostatic chamber to the external electrodes 20a and 20b via wires connected to the thermostatic chamber. The DC current I is measured, and the DC resistivity ρ can be calculated. Unless otherwise specified, measurements are performed in accordance with Japanese Industrial Standards C5101-22:2021, Fixed Capacitors for Electronic Equipment—Part 22: General Rules for Each Type-Fixed Multilayer Ceramic Capacitors for Surface Mount, Type 2.

Next, the DC resistivity ρ is measured for the multilayer ceramic capacitors obtained at each firing temperature, and the firing temperature that maintains the highest resistivity is determined to be the optimal firing temperature. Generally, the firing temperature that is too low results in low density and low resistivity, while the firing temperature that is too high results in large ceramic grains and fewer grain boundaries, resulting in a decrease in resistivity.

Next, the relative dielectric constant ε of the multilayer ceramic capacitor obtained at the firing temperature that maintains the highest resistivity is calculated, along with the relative dielectric constants of the multilayer ceramic capacitors obtained by firing at temperatures −20° C. and +20° C. from the firing temperature that maintains the highest resistivity. The slope of a line is calculated using the least squares method based on these firing temperatures and relative dielectric constants. This value is used to determine the firing temperature dependence of the dielectric constant (Δε/° C.) and serve as an indicator of high mass productivity.

Next, the reliability of the multilayer ceramic capacitor 100 obtained at the firing temperature that maintains the highest resistivity is examined. The reliability is determined by conducting a 50V-150° C. HALT test. The HALT life is calculated by averaging the values of 100 samples.

The DC resistivity measured at 150° C. is preferably 1.0×10⁸ Ω·cm or greater. The DC resistivity of 1.0×10⁸ Ω·cm or greater allows the multilayer ceramic capacitor 100 using the dielectric ceramic composition of this embodiment to have sufficient resistance.

The Δε/° C. is preferably 10 or less. When it is 10 or less, the multilayer ceramic capacitor 100 using the dielectric ceramic composition of this embodiment can be fired in a shorter time while suppressing changes in electrostatic capacity due to changes in firing temperature, enabling high mass productivity.

The relative dielectric constant ε is preferably 2000 or greater. Even if the DC resistivity measured at 150° C. is 2.0×10⁸ Ω·cm or more and the firing temperature dependency of the relative dielectric constant Δε/° C. is 12 or less, if ε is small, the electrostatic capacity Cp will ultimately be an insufficient value, and the characteristics will be unsuitable for use as the multilayer ceramic capacitor 100 using the dielectric ceramic composition.

For example, in the above embodiment, the multilayer ceramic capacitor is explained as an example of the multilayer ceramic electronic component, but the present invention can be applied to multilayer ceramic electronic components in general. Examples of such multilayer ceramic electronic components include chip varistors, chip thermistors, and multilayer inductors

### EXAMPLES

(Example 1) Molybdenum-doped barium titanate powder with an average particle size of 200 nm was prepared by adding 0.01 mol of MoO₃ to 100 mol of barium titanate during barium titanate synthesis. A dielectric ceramic composition was obtained by adding 0.75 mol of Gd₂O₃, 3.00 mol of TiO₂, 1.00 mol of MnCO₃, 1.00 mol of SiO₂, and 0.50 mol of MgO to 100 mol of the barium titanate powder.

The dielectric ceramic composition was mixed with ethanol, toluene, and PVB (polyvinyl butyral) resin to prepare a dielectric slurry. This slurry was formed into ceramic green sheets using a die coater. After drying, the ceramic green sheets were printed with nickel paste to form internal electrode patterns. The resulting stack units were stacked, and thick layers of ceramic green sheets without internal electrode patterns were pressed together on top and bottom. The stack was then cut into small pieces. Ni paste was then applied to the two end faces as a conductive paste for the external electrodes, and the pieces were de-bindered in nitrogen gas. The de-bindered pieces were fired and sintered in a reducing atmosphere controlled to an oxygen partial pressure sufficient to prevent nickel oxidation, producing multilayer ceramic capacitors. The firing was performed at 1000° C. for 10 minutes, followed by another 10 minutes at 1240° C.

The resulting multilayer ceramic capacitor measured 1005 shape (1.0 mm×1.0 mm×0.5 mm). It was then re-oxidized at 950° C. A plating process was then performed to form Cu, Ni, and Sn plated layers on the surface of the base layer, completing the multilayer ceramic capacitor. The average thickness of the dielectric layer 11 was 2.0 μm.

(Example 2) In Example 2, 0.03 mol of MoO₃ was added to 100 mol of barium titanate powder with a molybdenum solid dissolution and an average particle size of 200 nm. This powder was synthesized using 100 mol of barium titanate. To this powder, 0.75 mol of Gd₂O₃, 3.00 mol of TiO₂, 1.00 mol of MnCO₃, 1.00 mol of SiO₂, and 0.50 mol of MgO were added to obtain a dielectric ceramic composition. The firing was performed by maintaining the temperature at 1000° C. for 10 minutes, followed by 1230° C. for 10 minutes. Other conditions were the same as in Example 1.

(Example 3) In Example 3, 0.05 mol of MoO₃ was added to 100 mol of barium titanate powder with a molybdenum solid dissolution and an average particle size of 200 nm. This powder was synthesized using 100 mol of barium titanate. To this powder, 0.75 mol of Gd₂O₃, 3.00 mol of TiO₂, 1.00 mol of MnCO₃, 1.00 mol of SiO₂, and 0.50 mol of MgO were added to obtain a dielectric ceramic composition. The firing was performed by maintaining the temperature at 1000° C. for 10 minutes, and then at 1230° C. for 10 minutes. Other conditions were the same as in Example 1.

(Example 4) In Example 4, 0.07 mol of MoO₃ was added to 100 mol of barium titanate powder with a molybdenum solid dissolution and an average particle size of 200 nm. This powder was synthesized using 100 mol of barium titanate. To this powder, 0.75 mol of Gd₂O₃, 3.00 mol of TiO₂, 1.00 mol of MnCO₃, 1.00 mol of SiO₂, and 0.50 mol of MgO were added to obtain a dielectric ceramic composition. The firing was performed by maintaining the temperature at 1000° C. for 10 minutes, and then at 1220° C. for 10 minutes. Other conditions were the same as in Example 1.

(Example 5) In Example 5, 0.10 mol of MoO₃ was added to 100 mol of barium titanate powder with a molybdenum solid dissolution and an average particle size of 200 nm. This powder was synthesized using 100 mol of barium titanate. To this powder, 0.75 mol of Gd₂O₃, 3.00 mol of TiO₂, 1.00 mol of MnCO₃, 1.00 mol of SiO₂, and 0.50 mol of MgO were added to obtain a dielectric ceramic composition. The firing was performed by maintaining the temperature at 1000° C. for 10 minutes, and then at 1220° C. for 10 minutes. Other conditions were the same as in Example 1.

(Comparative Example 1) In Comparative Example 1, 0.75 mol of Gd₂O₃, 3.00 mol of TiO₂, 1.00 mol of MnCO₃, 1.00 mol of SiO₂, and 0.50 mol of MgO were added to 100 mol of barium titanate powder with an average particle size of 200 nm and no molybdenum solid-dissolved therein, to obtain a dielectric ceramic composition. The firing was performed by maintaining the temperature at 1000° C. for 10 minutes and then at 1240° C. for 10 minutes. Other conditions were the same as in Example 1.

For each of the multilayer ceramic capacitors in Examples 1 to 5 and Comparative Example 1, the electrostatic capacity Cp was measured at room temperature (25° C.) at 1 KHz and 1 Vrms using an LCR meter, and the DC current I was measured at 150° C. with an applied voltage of 60 V for 30 seconds using an insulation resistance meter. In addition, the cross sections along the lines A-A and B-B in FIG. 4 were exposed to calculate the effective area S of the internal electrode layers and the average thickness t of the dielectric layers. The relative dielectric constant & and the resistivity ρ were calculated from the effective area S and the average thickness t. The resistivities ρ of the multilayer ceramic capacitors of Examples 1 to 5 and Comparative Example 1 were compared, and the relative dielectric constants of the multilayer ceramic capacitors fired at temperatures of −20° C. and +20° C., starting with the multilayer ceramic capacitor obtained at the firing temperature with the highest resistivity, were compared. The slope of the line based on these firing temperatures and relative dielectric constants was calculated using the least-squares method, and this was defined as the firing temperature dependence of the dielectric constant (Δε/° C.).

Reliability tests were performed on the multilayer ceramic capacitors of Examples 1 to 5 and Comparative Example 1. If the average lifespan was at least twice that of Comparative Example 1, the reliability was evaluated as good (∘). If the average lifespan was less than twice that of Comparative Example 1, the reliability was evaluated as maintained or deteriorated, and the result was evaluated as unacceptable (x).

Furthermore, a conductive osmium material was vapor-deposited onto the exposed dielectric layer, and photographs of the crystalline grains present in the dielectric layer were taken using SEM observation. The average grain size of the crystal grains making up the dielectric layer was then calculated. The average grain size was 270 nm in Example 1, 260 nm in Example 2, 260 nm in Example 3, 280 nm in Example 4, 270 nm in Example 5, and 280 nm in Comparative Example 1.

In addition, during SEM observation of the multilayer ceramic capacitors, the presence of the second crystal grain 42 was confirmed by differences in their brightness in the BSE images.

Then, for each multilayer ceramic capacitor, a sample for TEM EDS observation was cut out using an FIB to confirm the composition of the shell portion and the core portion of the crystal grain in the dielectric layer and the second crystal grain 42. EDS composition evaluation was used to confirm whether the sample possessed a core-shell structure. An R/Ti elemental ratio of less than 0.02 was defined as the core portion, and the R/Ti elemental ratio of 0.02 or greater was defined as the shell portion.

Table 1 summarizes the amounts of additives added in Comparative Example 1 and Examples 1 to 5. Table 2 summarizes the firing temperatures, average grain sizes, ε, Δε/° C., resistivity at 150° C., and reliability relative to Comparative Example 1 for Comparative Example 1 and Examples 1 to 5. A pass/fail judgment was made for samples that met the following criteria: Δε/° C. of 10 or less, resistivity of 1.0×10⁸ Ω·cm or greater, and reliability of 2 or greater. The sample satisfying the criteria was judged as “acceptable”. The sample not satisfying the criteria was judged as “unacceptable”.

TABLE 1

| | MoO₃ | Gd₂O₃ | TiO₂ | MnCO₃ | SiO₂ | MgO |
|---|---|---|---|---|---|---|
| | (mol) | (mol) | (mol) | (mol) | (mol) | (mol) |
| COMPARATIVE | 0.00 | 0.75 | 3.00 | 1.00 | 1.00 | 0.50 |
| EXAMPLE 1 | | | | | | |
| EXAMPLE 1 | 0.01 | 0.75 | 3.00 | 1.00 | 1.00 | 0.50 |
| EXAMPLE 2 | 0.03 | 0.75 | 3.00 | 1.00 | 1.00 | 0.50 |
| EXAMPLE 3 | 0.05 | 0.75 | 3.00 | 1.00 | 1.00 | 0.50 |
| EXAMPLE 4 | 0.07 | 0.75 | 3.00 | 1.00 | 1.00 | 0.50 |
| EXAMPLE 5 | 0.10 | 0.75 | 3.00 | 1.00 | 1.00 | 0.50 |

TABLE 2

| | | AVERAGE | | | | | |
|---|---|---|---|---|---|---|---|
| | FIRING | GRAIN | | | RESISTIVITY | RELIABILITY | |
| | TEMPERATURE | SIZE | | | @150° C. | TEST | |
| | (° C.) | (nm) | ε | Δ ε/° C. | (Ω · m) | @150° C. | JUDGE |
| COMPARATIVE | 1240 | 280 | 3200 | 5.1 | 2.00 × 10¹⁰ | x | x |
| EXAMPLE 1 | | | | | | | |
| EXAMPLE 1 | 1230 | 270 | 3200 | 5.7 | 1.20 × 10¹⁰ | ∘ | ∘ |
| EXAMPLE 2 | 1230 | 260 | 3200 | 4.9 | 8.80 × 10⁹ | ∘ | ∘ |
| EXAMPLE 3 | 1230 | 260 | 3300 | 4.2 | 3.30 × 10⁹ | ∘ | ∘ |
| EXAMPLE 4 | 1220 | 280 | 3400 | 5.8 | 1.80 × 10⁹ | ∘ | ∘ |
| EXAMPLE 5 | 1220 | 270 | 3200 | 3.5 | 5.70 × 10⁸ | ∘ | ∘ |

Furthermore, to investigate the mechanism of the dielectric layer in detail, STEM-EDS was used to examine the presence or absence of the core-shell structure, the Mo to Ti elemental ratio in the first crystal grain 41, the presence or absence of the second crystal grain 42, and the Ba to Ti elemental ratio in the second crystal grain 42 for the multilayer ceramic capacitors obtained in Comparative Example 1 and Examples 1 to 5. The results are summarized in Table 3. In all of Comparative Example 1 and Examples 1 to 5, the second crystal grain 42 with a barium to titanium elemental ratio of 0.70 or less was confirmed. However, while the first crystal grain 41 having a molybdenum-containing core and a shell containing a rare earth element and manganese were observed in Examples 1 to 5, no molybdenum was detected in the core in Comparative Example 1. This is likely due to the use of barium titanate without molybdenum solid dissolution in Comparative Example 1.

TABLE 3

| | SHELL PORTION | | | CORE PORTION | | | SECOND CRYSTAL GRAIN | | |
|---|---|---|---|---|---|---|---|---|---|
| | R/Ti | Mn/Ti | Mo/Ti | R/Ti | Mn/Ti | Mo/Ti | Ba/Ti | Mn/Ti | Mo/Ti |
| | ELE- | ELE- | ELE- | ELE- | ELE- | ELE- | ELE- | ELE- | ELE- |
| | MENTAL | MENTAL | MENTAL | MENTAL | MENTAL | MENTAL | MENTAL | MENTAL | MENTAL |
| | RATIO | RATIO | RATIO | RATIO | RATIO | RATIO | RATIO | RATIO | RATIO |
| COMPARATIVE | 0.052 | 0.025 | — | 0.004 | 0.003 | — | 0.468 | 0.052 | — |
| EXAMPLE 1 | | | | | | | | | |
| EXAMPLE 1 | 0.051 | 0.027 | 0.001 | 0.006 | 0.004 | 0.002 | 0.586 | 0.065 | 0.003 |
| EXAMPLE 2 | 0.055 | 0.023 | 0.004 | 0.005 | 0.004 | 0.003 | 0.498 | 0.054 | 0.001 |
| EXAMPLE 3 | 0.060 | 0.030 | 0.005 | 0.003 | 0.006 | 0.005 | 0.471 | 0.051 | 0.001 |
| EXAMPLE 4 | 0.047 | 0.026 | 0.006 | 0.004 | 0.002 | 0.007 | 0.534 | 0.063 | 0.002 |
| EXAMPLE 5 | 0.057 | 0.023 | 0.009 | 0.003 | 0.005 | 0.008 | 0.511 | 0.054 | 0.002 |

As shown in Table 2, Examples 1 to 5 had Δε/° C. values of 10 or less. For example, even when a larger firing furnace than existing furnaces was used to increase productivity, the relative dielectric constant obtained with respect to the temperature distribution within the furnace, for example, the electrostatic capacity Cp of a multilayer ceramic capacitor, did not show a large distribution. This allows for mass production even with rapid heating and short firing times. Furthermore, the appropriate amount of molybdenum provided reliability more than twice that of Comparative Example 1.

All of Examples 1 to 5 were judged as “acceptable.” This is believed to be because the dielectric layers in Examples 1 to 5 contained the first crystal grain 41 and the second crystal grain 42. This is a surprising effect that was not anticipated in conventional dielectric ceramic compositions. In contrast, Comparative Example 1 was judged as “unacceptable”. This is believed to be because the dielectric layers in Comparative Example 1 did not contain the first crystal grain 41.

Although the embodiments of the present invention have been described in detail above, the present invention is not limited to the specific embodiments, and various modifications and changes are possible within the scope of the gist of the present invention described in the claims.

What is claimed is:

1. A multilayer ceramic electronic component comprising:
a dielectric layer including first crystal grains and second crystal grains, the first crystal grains having a perovskite structure represented by a general formula ABO₃ and having a core portion containing molybdenum and a shell portion, the shell portion covering the core portion and containing a rare earth element and manganese, the second crystal grains including as a main component, a barium-titanate-based composite oxide having an elemental ratio of barium to titanium of 0.70 or less;
internal electrode layers sandwiching the dielectric layer; and
external electrodes electrically connected to the internal electrode layers, respectively.

2. The multilayer ceramic electronic component according to claim 1,
wherein an A site of the perovskite structure includes barium, and
wherein an element included at a B site of the perovskite structure includes at least one of titanium or zirconium.

3. The multilayer ceramic electronic component according to claim 1,
wherein the rare earth element is at least one selected from a group consisting of lanthanum, cerium, praseodymium, neodymium, promethium, samarium, europium, gadolinium, terbium, dysprosium, holmium, erbium, and ytterbium.

4. The multilayer ceramic electronic component according to claim 1,
wherein an element at a B site of the perovskite structure includes titanium, and
wherein an elemental ratio of molybdenum to titanium of the first crystal grains is 0.001 or more.

5. The multilayer ceramic electronic component according to claim 1, wherein an elemental ratio of molybdenum to titanium of the second crystal grains is less than 0.01.

6. The multilayer ceramic electronic component according to claim 1, wherein the second crystal grains include at least one selected from BaTi₄O₉, BaTi₅O₁₁, BaTi₆O₁₃, Ba₄Ti₁₁O₂₆, Ba₄Ti₁₂O₂₇, Ba₄Ti₁₃O₃₀, or Ba₆Ti₁₇O₄₀.

7. The multilayer ceramic electronic component according to claim 1, wherein a maximum grain size of the first crystal grains is 2 μm or less.

8. The multilayer ceramic electronic component as claimed in claim 1, wherein the shell portion includes magnesium and manganese.

9. A dielectric ceramic composition, comprising:
first crystal grains having a perovskite structure represented by a general formula ABO₃, each first crystal grain having a core portion containing molybdenum and a shell portion, the shell portion covering the core portion and containing a rare earth element and manganese; and
second crystal grains whose main component is a barium titanate-based composite oxide in which an elemental ratio of barium to titanium is 0.70 or less.
